(19) United States
(12) Patent Application Publication
(10) Pub. No.: US 2025/0271321 A1
(43) Pub. Date: Aug. 28, 2025

(54) TORQUE WRENCH CALIBRATION AUTOMATION SYSTEM

(71) Applicant: Yu-Shin KANG, Daejeon (KR)

(72) Inventors: Yu-Shin KANG, Daejeon (KR); Cheolgyu KIM, Sejong (KR); Seheon OH, Gyeonggi-do (KR); Yun Sang CHOI, Sejong (KR); Juseok LEE, Gyeonggi- do (KR)

(21) Appl. No.: 18/858,411

(22) PCT Filed: Apr. 19, 2023
(86) PCT No.: PCT/KR2023/005295

§ 371 Date: Oct. 21, 2024

(30) Foreign Application Priority Data
Apr. 20, 2022 (KR) 10-2022-0048800

(51) Int. Cl. G01L 25/00

(52) U.S. Cl. CPC G01L 25/003

(57) ABSTRACT

A torque wrench calibration automation system comprises: a body part; a handle rotation drive part; and a handle push drive part, wherein the body part includes a calibrator that collects data, transmits the data, and receives control signals, a head fixing part that fixes the position of a head part of a torque wrench, a body part base with a flat top surface, and a handle base that moves linearly from the top of the body part base; the handle rotation drive part includes a handle rotation motor installed on the handle base of the body part, and a handle rotation module connected to the front end of the handle rotation motor and rotating the handle part of the torque wrench; and the handle rotation module includes an air pressure supply part that provides air pressure required when mounting or dismounting the handle part of the torque wrench.

### TECHNICAL FIELD

The present invention relates to a torque wrench calibration automation system, and more specifically, to a torque wrench calibration automation system, which enables more accurate measurement and calibration by eliminating backlash between a handle part and body portion of a torque wrench.

### BACKGROUND ART

In general, bolt-fastening is widely used for joining members when producing products or structures.

Compared to other joining methods such as welding, riveting, and an adhesive, since bolt-fastening work is simple, there are advantages that even unskilled workers can easily perform bolt-fastening and aftercare is easy. However, when care is not taken in work and management, there is a concern that bolt-fastening may be released, resulting in a serious accident.

Meanwhile, since the accuracy of fastening device, such as a torque wrench, used for fastening bolts decreases due to wear, environmental changes, or the like, the accuracy of fastening devices, such as a torque wrench, should be inspected regularly, and the history thereof should be managed to determine whether to repair, calibrate, or replace the fastening devices.

The conventional torque wrench calibration method uses a method of acquiring a measured value by manipulating a handle with a worker's hand while the worker directly visually identifies the scale of a torque wrench using a torque measurement device. In this case, there is a problem that the accuracy and repeatability of the measured value is significantly reduced due to an angle of viewing the scale, eyesight, and the like, and it is also difficult to precisely control the torque by handling. In addition, since it is a specialized field, when one person works in the same field for a considerable time, he or she may get an occupational disease due to the work. Due to the nature of torque wrench manipulation operation, turning a handle dozens of times or more a day often puts a strain on the wrist joint, often causing chronic arthritis in the wrist area.

As a solution to solve this problem, a torque wrench calibration automation system that is more automated than the conventional one has been proposed.

For example, a technology for a torque wrench calibration automation system is disclosed in Korean Patent No. 10-1104671. The torque wrench calibration automation system includes a motor for applying a torque to a torque wrench, a camera for photographing the scale of the torque wrench in response to the application of the torque, a control unit for outputting a measured torque value based on an output image of the camera and outputting an error torque value, and a display unit for displaying the error torque value and the measured torque value. The conventional torque wrench calibration automation system is different in that it is not a calibration automation method for a general preset type torque wrench, and the torque wrench calibration automation system has difficulty in controlling and measuring the amount of torque. In addition, according to the related art, there that the torque wrench automatic is a disadvantage calibration system malfunctions at a low measurement point, and in severe cases, may damage the torque wrench.

Korean Patent No. 10-2330784 discloses a technology for a preset type torque wrench calibration automation system that presents a solution to solve the above problem. However, since the preset torque wrench is formed by assembling several parts due to its nature, a gap inevitably occurs at a fastened portion of moving parts, and “backlash,” which is the relative movement between engaged mechanical parts, occurs, and in particular, a hysteresis phenomenon occurs in response to a rotating area (power transmission area). Therefore, there is a problem that a “handle slip” phenomenon in which a handle does not turn as instructed by software occurs.

### SUMMARY OF THE INVENTION

The purposes of the present invention are directed to solving the above problems of the related art, that is, problems such as that it is difficult to control and measure the amount of torque, a disadvantage that a torque wrench automatic calibration system malfunctions at a low measurement point, the possibility of damage to the torque wrench and the occurrence of backlash, the occurrence of a hysteresis phenomenon, and the occurrence of a “handle slip” phenomenon in which a handle does not turn as instructed by software.

### TECHNICAL SOLUTION

To solve the above problems of the related art, the present inventors invented a torque wrench calibration automation system that is capable of eliminating the backlash between a handle part and a body portion by installing an elastic contact member on a side surface of a jaw to first slightly turn a side surface of a handle part before a front surface of the jaw comes into contact with an outer circumferential surface of the handle part of a torque wrench.

### ADVANTAGEOUS EFFECTS

According to a torque wrench calibration automation system according to embodiments of the present invention, by installing an elastic contact member on a side surface of a jaw provided on a chuck of a handle rotation driving unit to apply a force so that the elastic contact member comes into contact with an outer circumferential surface of a handle part to rotate the handle part before the outer circumferential surface of the handle part of the torque wrench is firmly held by the jaw, it is possible to eliminate the backlash between the handle part and body portion of a torque wrench.

Therefore, according to the torque wrench calibration automation system according to embodiments of the present invention, it is possible to prevent the occurrence of a “handle slip” phenomenon in which the handle part does not immediately rotate even in response to a software control signal as backlash occurs, eliminate a hysteresis phenomenon occurring in response to a rotating area, and always accurately collect and calibrate data.

In addition, according to the torque wrench calibration automation system according to embodiments of the present invention, since an air cylinder is installed and the elastic contact member is configured to apply a force in a direction away from the side surface of the jaw, it is possible to eliminate a phenomenon that the elastic contact member is bent inward or a problem that interference with the handle part of the torque wrench occurs during measurement.

### BRIEF DESCRIPTION OF DRAWINGS

FIG. 1 is a perspective view showing a torque wrench calibration automation system according to one embodiment of the present invention.

FIG. 2 is a right-side perspective view showing a state in which a handle part of a torque wrench is held by a handle rotation driving unit in the torque wrench calibration automation system according to one embodiment of the present invention.

FIG. 3 is a perspective view showing a jaw with an elastic contact member installed in the torque wrench calibration automation system according to one embodiment of the present invention.

FIG. 4 is a partial cross section perspective view showing the jaw with the elastic contact member installed in the torque wrench calibration automation system according to one embodiment of the present invention.

FIG. 5 is a front view showing a chuck with three jaws installed in the torque wrench calibration automation system according to one embodiment of the present invention.

FIG. 6 is a front view of the chuck with three jaws installed showing a state in which the elastic contact member stretches in the torque wrench calibration automation system according to one embodiment of the present invention.

FIG. 7 is a schematic perspective view showing an example of a torque wrench.

FIG. 8 is a schematic plan view showing an internal configuration of the torque wrench.

FIG. 9 is a schematic plan view showing a state in which the torque wrench is in operation.

FIG. 10 is a schematic perspective view showing an example of a snap ring type torque wrench.

FIG. 11 is a partially enlarged perspective view schematically showing an example of the snap ring type torque wrench.

### DETAILED DESCRIPTION OF THE INVENTION

A torque wrench calibration automation system according to an embodiment of the present invention includes a main body, a handle rotation driving unit, and a handle push driving unit.

The main body may include a reference part for collecting data required for calibration, transmitting the data, and receiving a control signal, a head fixing part for fixing a position of a torque wrench head, a main body base having a flat upper surface, and a handle base that moves linearly on an upper surface of the main body base.

The handle rotation driving unit is installed on the handle base of the main body and performs an operation of mounting and supporting a handle part of the torque wrench, which is spaced a set height from the handle base of the main body, and rotating the mounted handle part of the torque wrench.

The handle push driving unit is installed on the main body base of the main body and performs an operation of pushing or pulling a handle push base forward and backward by being connected to a rear end of the handle base of the main body.

The handle rotation driving unit may include a handle rotation motor installed on the handle base of the main body and a handle rotation module connected to a front end of the handle rotation motor and receiving a rotational force of the handle rotation motor to rotate the handle part of the torque wrench.

The handle rotation module may include a pneumatic supply unit for providing the pneumatic pressure necessary for mounting or dismounting the handle part of the torque wrench, and a chuck that operates by having a plurality of jaws operating to grip or release a rear end of the handle part of the torque wrench in a circumferential direction using the pneumatic pressure provided from the pneumatic supply unit to mount the torque wrench on the main body.

An elastic contact member made of an elastic material may be installed on one side surface of each of the plurality of jaws.

Preferably, the elastic contact member is installed in a protruding state to come into contact with the outer circumferential surface of the handle part earlier than a front end surface of the jaw coming into contact with the handle part of the torque wrench and installed to move away from and then come into close contact with the side surface of the jaw.

By mounting an air cylinder between the elastic contact member and the jaw to allow a force to be applied to the elastic contact member in a direction opposite to a direction that is in close contact with the side surface of the jaw when the elastic contact member stretches in a direction away from the side surface of the jaw as the elastic contact member comes into contact with the outer circumferential surface of the handle part of the torque wrench, the elastic contact member may be configured so as not to come into contact with the handle part of the torque wrench.

In addition, a restoring spring may be further installed between the elastic contact member and the jaw to help a function of first bringing the elastic contact member into close contact with the side surface of the jaw when the jaw performs an inward constricting operation to hold the handle part of the torque wrench. With this configuration, the elastic contact member can perform a function of preventing the backlash of the handle immediately before the jaw completely holds the handle part of the torque wrench.

### Description of Drawing Symbols

10—torque wrench, 11—head, 12—direction change button, 13—body portion, 14—alarm portion
15—spring, 16—adjustment portion, 17—handle part, 100—snap ring torque wrench
110—head, 120—direction change button, 130—body portion, 140—main scale portion
150—rotation auxiliary scale portion, 160—snap ring, 170—handle part, 200—main body
210—reference part, 230—head fixing unit, 240—main body base, 250—handle base
251—handle base front groove, 253—handle base front protrusion bar,
260—linear motion guide, 261—guide rail, 263—first guide block
270—handle push base, 271—first handle push base body
273—second handle push base, 275—second handle push base, 277—connection pin
280—support, 281—first support body, 283—second support body
285—third support body, 300—handle rotation driving unit, 310—handle rotation motor
320—handle rotation module, 321—pneumatic supply unit, 323—chuck, 325—jaw
330—elastic contact member, 332—hinge pin, 335—air cylinder, 400—reaction bar
500—handle push driving unit, 510—handle push motor, 520—lead screw
800—integrated control unit, 1000—torque wrench calibration automation system

Next, exemplary embodiments of a torque wrench calibration automation system according to the present invention will be described in detail with reference to the accompanying drawings.

The present invention may be implemented in various forms and is not limited to embodiments described below.

Hereinafter, to clearly describe the present invention, detailed descriptions of parts that are not closely related to the present invention are omitted, and the same or similar components are denoted by the same reference numeral throughout the description of the invention, and repetitive descriptions will be omitted.

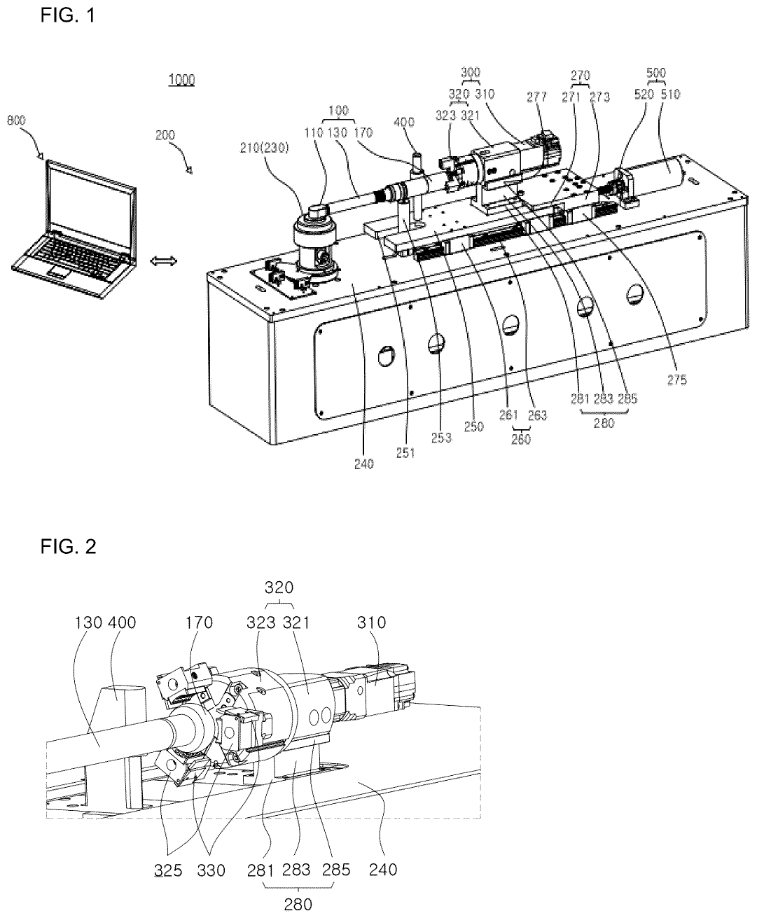

First, as shown in FIG. 1, a torque wrench calibration automation system according to one embodiment of the present invention includes a main body 200, a handle rotation driving unit 300, and a handle push driving unit 500.

In FIG. 1, reference numeral 1000 denotes a torque wrench calibration automation system according to one embodiment of the present invention, and reference numeral 800 denotes an integrated control unit.

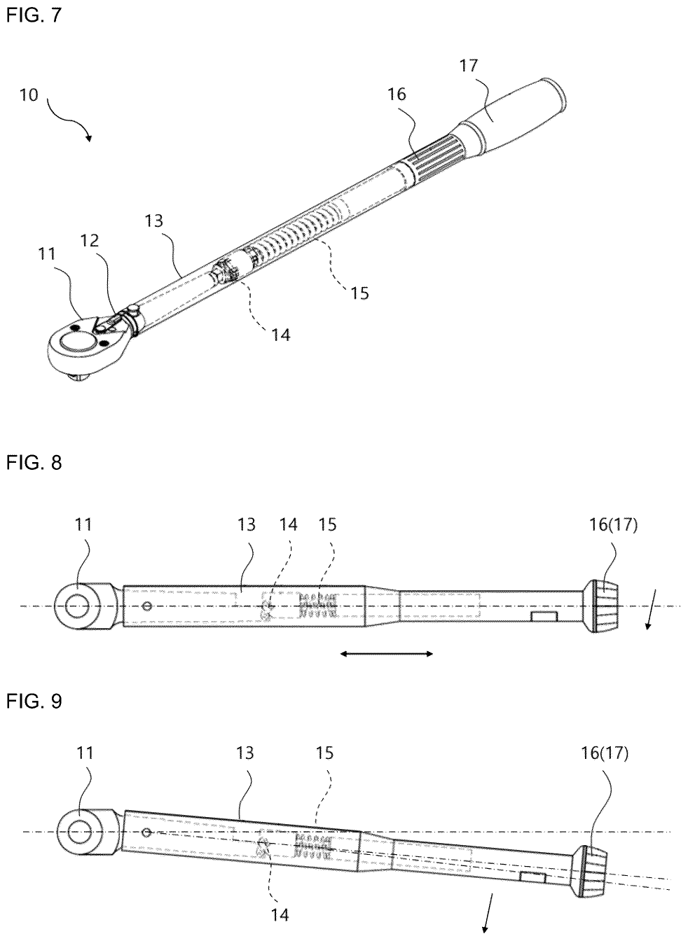

In addition, FIGS. 7 to 9 show an example of a torque wrench 10 that is calibrated using the torque wrench calibration automation system according to one embodiment of the present invention.

The torque wrench 10 includes a head 11, a direction change button 12, a body portion 13, an alarm portion 14, a spring 15, an adjustment portion 16, and a handle part 17.

The torque wrench 10 formed as described above adjusts a set value to a set scale using the adjustment portion 16.

For example, the adjustment portion 16 may be provided in a ring shape and may adjust the set value in a method in which the spring 15 is elastically pressed or elastically restored according to the rotation of the adjustment portion 16.

After the set value is adjusted in this way, the torque wrench 10 is rotated by pulling the handle part 17 after connecting the head 11 to a nut or bolt. In this case, when the handle part 17 turns in a direction of force, the torque wrench 10 rotates.

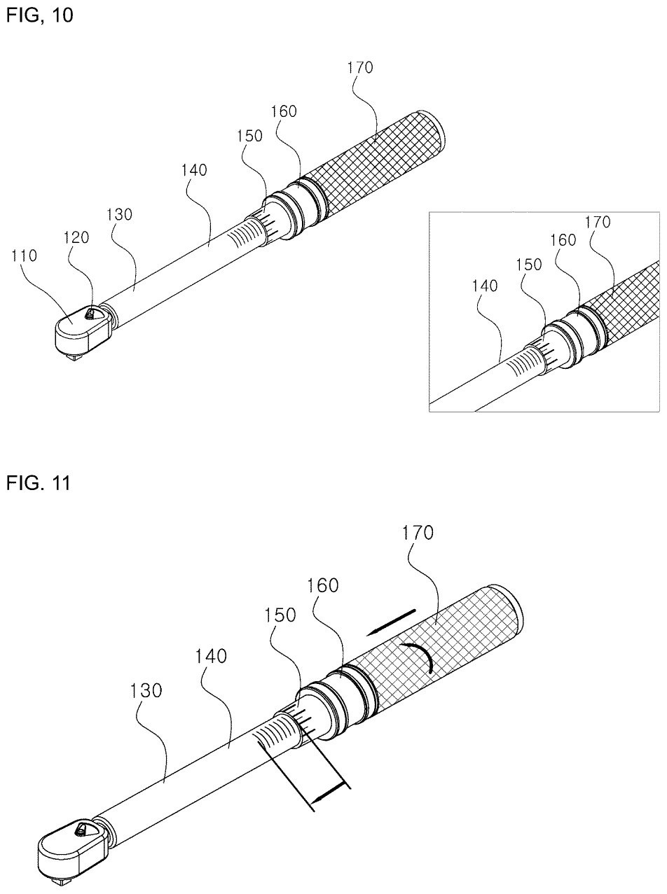

Meanwhile, within a set value range adjusted using the adjustment portion 16, the torque wrench 10 maintains an overall straight shape and rotates in a direction in which the force is applied (see FIG. 9). However, when reaching a set value level, the torque wrench 10 has a shape in which the body portion 13 is momentarily bent at a predetermined angle (see FIG. 10).

Specifically, when the handle part 17 turns in a direction of force, a joint area of the alarm portion 14 is slightly misaligned, bending occurs between the head 11 and the body portion 13, and a predetermined angle is formed between the head 11 and the body portion 13.

As a manual system for calibrating the torque wrench 10 formed and operated as described above, there is a torque wrench calibration system in the form of pulling and releasing the handle part 17 using a rotating handle. In this case, the rotating handle of the torque wrench calibration system turns to push the body portion 13 of the torque wrench 10, and the alarm portion 14 generates a sound at a random set value to detect a bending phenomenon. At this time, the user stops manipulating the rotating handle and checks a value of the reference part of the torque wrench calibration system. However, in this case, a user needs to manually turn the rotating handle, audibly check the sound of the alarm portion 14, and visually check the value of the reference part, which is laborious and has a disadvantage of low measurement precision.

In addition, FIGS. 10 and 11 show an example of a snap ring type torque wrench.

For example, a snap ring type torque wrench 100 includes a head 110, a direction change button 120, a body portion 130, a main scale portion 140, a rotation auxiliary scale portion 150, a snap ring 160, and a handle part 170.

In the snap ring type torque wrench 100, first, the snap ring 160 is pulled forward to align a measurement point and then the handle part 170 is rotated to position the handle part 170 at a desired scale on the rotation auxiliary scale portion 150. The handle part 170 is configured to move forward and backward in a longitudinal direction at a rear end of the body portion 130 along internal screw thread, and the total length of the torque wrench 100 may be variably adjusted. At the same time, the snap ring type torque wrench 100 may also change a ‘force application point’ with respect to the center of the head 110.

Hereinafter, although an example in which the snap ring type torque wrench 100 shown in FIGS. 10 and 11 is applied to the torque wrench calibration automation system according to one embodiment of the present invention will be described, the present invention is not limited thereto, and the torque wrench 10 shown in FIGS. 7 to 9 may be applied, and calibration may be performed by applying torque wrenches with various configurations.

In addition, as shown in FIG. 1, the torque wrench calibration automation system according to one embodiment of the present invention may include a reference part 210 for collecting data necessary for calibrating the main body 200, transmitting the data, and receiving a control signal, a head fixing unit 230 for fixing a position of the head 110 of the torque wrench 100, a main body base 240 having a flat upper surface, and a handle base 250 that moves linearly on an upper portion of the main body base 240.

The main body 200 performs a function of setting and supporting the torque wrench 100.

The reference part 210 is connected to an integrated control unit 800 in a wired/wireless manner to perform a function of transmitting data and receiving control signals.

Since the configuration of the reference part 210 may be implemented in any of various configurations used in various general experiments and measuring devices, detailed description thereof will be omitted.

In addition, as shown in FIGS. 1 and 2, the handle rotation driving unit 300 is installed on the handle base 250 of the main body 200, supports a mounted handle part 170 of the torque wrench (100) that is spaced a set height from the handle base 250 of the main body 200, and performs an operation of rotating the mounted handle part 170 of the torque wrench 100.

The handle rotation driving unit 300 may include a handle rotation motor 310 installed on the handle base 250 of the main body 200, and a handle rotation module 320 connected to a front end of the handle rotation motor 310 and receiving a rotational force of the handle rotation motor 310 to rotate the handle part 170 of the torque wrench 100.

The handle rotation motor 310 functions as a driving source for providing the rotational force required to rotate the handle part 170 of the torque wrench 100.

The handle rotation module 320 stably supports the handle part 170 of the torque wrench 100 in a horizontal state and transmits the rotational force of the handle rotation motor 310 to the handle part 170 of the torque wrench 100.

For example, the handle rotation module 320 may be connected to and installed on a front end of the handle rotation motor 310.

The handle rotation module 320 may include a pneumatic supply unit 321 for providing the pneumatic pressure required for mounting or dismounting the handle part 170 of the torque wrench 100, and a chuck 323 that operates by having a plurality of jaws 325 operating to hold or release a rear end of the handle part 170 of the torque wrench 100 using the pneumatic pressure provided from the pneumatic supply unit 321 in a circumferential direction to mount the torque wrench 100 on the main body 200.

The pneumatic supply unit 321 provides the pneumatic pressure required for mounting or dismounting the handle part 170 of the torque wrench 100.

In one embodiment of the present invention, although it is described that the number of jaws 325 are three, the number of jaws may be four, and the number of jaws 325 is not important.

When the number of jaws 325 are three, it is possible to stably support an outer surface of the handle part 170 of the torque wrench 100 in a three-point support manner by being spaced apart at uniform intervals at 120 degrees in the circumferential direction.

The three jaws 325 may be moved toward or away from the outer circumferential surface of the handle part 170 by the pneumatic pressure, and the handle part 170 is fixed (held) or released from the holding in conjunction with the movement of the three jaws 325.

In addition, as shown in FIGS. 2 to 4, an elastic contact member 330 made of an elastic material may be installed on one side surface of each of the plurality of jaws 325.

Preferably, the elastic contact member 330 is installed in a protruding state to come into contact with the outer circumferential surface of the handle part 170 earlier than a front end surface of the jaw 325 coming into contact with the handle part 170 of the torque wrench 100 and installed to move away from and then come into close contact with the side surface of the jaw 325.

For example, the elastic contact member 330 may be rotatably installed on one side surface of the jaw 325 using a hinge pin 332.

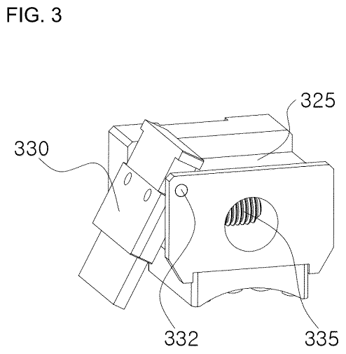

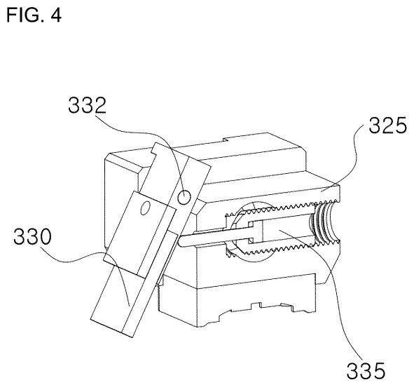

In addition, as shown in FIGS. 3 and 4, an air cylinder 335 may be further installed between the elastic contact member 330 and the jaw 325 to apply a force to the elastic contact member 330 in a direction away from the side surface of the jaw 325 of the elastic contact member 330.

The air cylinder 335 is installed to apply a force to the elastic contact member 330 in a direction opposite to a direction in which the elastic contact member 330 is in close contact with the side surface of the jaw 325 when stretching in a direction away from the side surface of the jaw 325 as a front end portion of the elastic contact member 330 comes into contact with the outer circumferential surface of the handle part 170 of the torque wrench 100, and configured to prevent the elastic contact member 330 from coming into contact with the handle part 170 of the torque wrench 100 during an experiment.

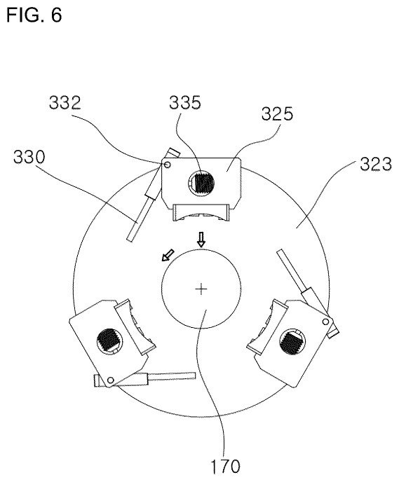

When the air cylinder is installed as described above, as shown in FIG. 6, when the jaw 325 moves toward the handle part 170 of the torque wrench 100, the air cylinder 335 may be operated so that the elastic contact member 330 stretches in a direction away from the side surface of the jaw 325, thereby preventing the front end portion of the elastic contact member 330 from being curved and bent inward when coming into contact with the outer circumferential surface of the handle part 170.

In the above, preferably, the air cylinder 335 is configured to release pressure before the front end portion of the elastic contact member 330 comes into contact with the outer circumferential surface of the handle part 170 and comes into contact with the outer circumferential surface of the handle part 170 earlier than the front end surface of the jaw 325 while rotating so that the elastic contact member 330 approaches the side surface of the jaw 325 by an elastic force of a restoring spring (not shown).

In addition, in a state in which the holding of the handle part 170 is completed by the jaw 325 or the jaw 325 is opened for measurement, the air cylinder 335 may be operated to maintain a state in which the elastic contact member 330 stretches away from the side surface of the jaw 325 to solve a problem that the elastic contact member 330 comes into contact with the outer circumferential surface of the handle part 170, thereby causing interference during measurement.

In addition, although not shown in the drawings, a restoring spring may be further installed between the elastic contact member 330 and the jaw 325 to apply a force in a direction in which the front end portion of the elastic contact member 330 comes into close contact with the side surface of the jaw 325.

The restoring spring is installed to help the function of first bringing the elastic contact member 330 into close contact with the jaw 325 when the jaw 325 narrows inward to hold the handle part 170 of the torque wrench 100.

With the above configuration, the elastic contact member 330 may perform a function of preventing the backlash of the handle part 170 by first coming into contact with the handle part 170 immediately before the jaw 325 completely holds the handle part 170 of the torque wrench 100.

Although not shown in the drawings, the restoring spring may be formed as a torsional spring and installed on the hinge pin 332 to apply a force to the elastic contact member 330 in a direction in which the elastic contact member 330 comes into close contact with the side surface of the jaw 325.

In addition, the restoring spring may be formed as a coil spring and installed between the elastic contact member 330 and the side surface of the jaw 325 to apply a force to the elastic contact member 330 in a direction in which the elastic contact member 330 comes into close contact with the side surface of the jaw 325.

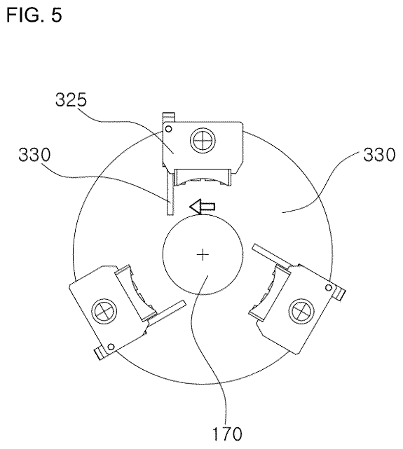

When the elastic contact member 330 is installed as described above, as shown in FIG. 5, as the three jaws 325 approach the handle part 170 of the torque wrench 100, the elastic contact member 330 comes into contact with the outer circumferential surface of the handle part 170 earlier than the front end surface of the jaws 325, and as the front end portion of the elastic contact member 330 is deformed to be bent outward, a force due to elastic force is applied to the handle part 170 in a circumferential direction, and the handle part 170 rotates to eliminate backlash.

Therefore, when the jaw 325 holds the handle part 170 in a state of being in close contact with the outer circumferential surface of the handle part 170, no slippage occurs as the chuck 323 rotates, and the rotational force is directly transmitted to the torque wrench 100 through the handle part 170, thereby enabling accurate operation and measurement.

In addition, as shown in FIG. 1, the torque wrench calibration automation system according to one embodiment of the present invention is provided with the handle push driving unit 500 on the main body base 240 of the main body 200 and performs an operation of pushing or pulling the handle push base 270 forward and backward by being connected to the rear end of the handle base 250 of the main body 200.

In addition, as shown in FIG. 1, the torque wrench calibration automation system according to one embodiment of the present invention may further include a linear motion guide 260.

The linear motion guide 260 is installed between the main body base 240 and the handle base 250 and performs a function of guiding the linear movement of the handle base 250.

For example, the linear motion guide 260 may include a guide rail 261 positioned on an upper portion of the main body base 240 and linearly disposed parallel to a longitudinal direction of the torque wrench 100, and a first guide block 263 installed under the handle base 250 and coupled to the guide rail 261 to move linearly along the guide rail 261.

In addition, the linear motion guide 260 may further include a second guide block 275 installed under the handle push base 270 and coupled to the guide rail 261 at a predetermined interval forward and backward from the first guide block 263 to move linearly along the guide rail 261.

Meanwhile, the torque wrench calibration automation system according to the embodiment of the present invention may be further formed with a linear long hole (not shown) in the longitudinal direction of the snap ring type torque wrench 100 at the rear end of the handle base 250.

In the above, the linear long hole is preferably formed to have a length corresponding to the total movement distance of the main scale portion 140 of the snap ring type torque wrench 100.

The handle push base 270 may include a first handle push base body 271 connected to the rear end of the handle base 250 and a second handle push base body 273 formed integrally with the first handle push base body 271 and having a greater thickness than the first handle push base body 271.

In addition, the second guide block 275 may be coupled to a lower portion of the second handle push base body 273.

A detachably coupled connection pin 277 may be further installed on the first handle push base body 271.

The connection pin 277 may be inserted through the linear long hole having a length corresponding to the total movement distance of the main scale portion 140 of the torque wrench 100.

When the connection pin 277 is formed as described above, the connection pin 277 may connect or disconnect the handle base 250 to or from the handle push base 270.

With the above configuration, the handle push base 270 may push or pull the handle base 250 installed on the linear motion guide 260.

The connection pin 277 connecting the handle push base 270 to the handle base 250 may be positioned inside the linear long hole formed in the handle base 250, and the entirety of the handle base 250 may move forward or backward depending on the length of the linear long hole.

The mechanism for moving the handle base 250 forward and backward using the linear long hole formed in the handle base 250 can simplify the configuration for controlling a position of a reaction bar 400 and achieve cost reduction and efficiency improvement.

A reaction bar 400 constitutes an application point of the torque wrench 100.

For example, the total length of the torque wrench 100 may change depending on the rotation of the handle part 170, and thus a position of the application point of the torque wrench 100 changes, and a position of the reaction bar 400 constituting the application point needs to be controlled.

With the above configuration, a structure in which the handle rotation driving unit 300 for rotating the handle part 170 of the torque wrench 100 is fixedly positioned above the handle base 250 and the handle base 250 may move forward and backward in a direction that is set by the linear motion guide 260 by a screw inside the torque wrench 100 when the handle part 170 rotates is implemented.

Therefore, when the handle rotation motor 310 is driven to rotate the handle part 170 in a state in which the handle part 170 is fixedly engaged by the operation of the three jaws 325, there is an advantage that the reaction bar 400 installed to protrude upward from one side of the handle base 250 may move together with the handle base 250, thereby maintaining the position (position of the application point) of the reaction bar 400.

The connection pin 277 may be formed in a structure that is detachably attached through the handle push base 270, and when the connection pin 277 is removed, the handle base 250 may be moved forward or backward in a manual manipulation manner.

In addition, as shown in FIG. 1, the torque wrench calibration automation system according to one embodiment of the present invention may further include a support 280.

The support 280 may be provided on the handle base 250 and may have a structure that protrudes upward to a predetermined height.

The support 280 may support the handle rotation driving unit 300 in a state of being spaced a set height from the handle base 250.

For example, the support 280 may include a first support body 281 fixedly installed to face an upper portion of the handle base 250 with a predetermined area, a second support body 283 that protrudes upward from an upper portion of the first support body 281 and has a smaller cross section than the first support body 281, and a third support body 285 that has a larger cross section than the second support body 283 at an upper end of the second support body 283.

A seating groove may be formed at an upper end of the third support body 285 so that the handle rotation motor 310 and/or the handle rotation module 320 of the handle rotation driving unit 300 are seated to extend horizontally.

In the above, the handle rotation module 320 and/or the handle rotation motor 310 may be surface-supported by being seated in the seating groove of the support 280 with a large area.

As the support 280 is formed as described above, the handle rotation motor 310 and the handle rotation module 320, which are heavy, may be stably horizontally disposed on the handle base 250, and as a result, the handle part 170 of the torque wrench 100 mounted on the three jaws 325 of the chuck 323 of the handle rotation module 320 may be stably supported at a predetermined height, and it is possible to reduce an error in the calibration work of the torque wrench 100 and improve accuracy and reliability.

In addition, as shown in FIG. 1, the handle push driving unit 500 may include a handle push motor 510 and a lead screw 520.

The handle push motor 510 is fixedly installed at a rear end of the main body base 240.

The lead screw 520 receives a rotational force of the handle push motor 510 to rotate and is fastened to a nut block fixed to the handle push base 270 to move the handle push base 270 forward and backward using the rotational force of the handle push motor 510.

When the handle push base 270 moves forward and backward as described above, the handle base 250 linearly moves a set distance forward and backward.

The integrated control unit 800 is configured to control the operations of the handle rotation motor 310 and the handle push motor 510 and collect the measured data of the reference part 210.

As the integrated control unit 800, a PC, a laptop computer, or any of various other user wireless terminals may be used, and it is possible to also use any of various devices that are obvious to those skilled in the art.

The integrated control unit 800 may perform a measurement point setting process of the torque wrench 100.

The measurement point setting process includes a process of dividing the lowest measurement point and the highest measurement point, a value corresponding to one rotation of the handle part 170, and one rotation of the handle part 170 into set values.

The integrated control unit 800 may control the handle part 170 of the torque wrench 100 to rotate to a measurement point automatically determined according to measurement point setting and control the rotation of the reference part 210 and acquire measurement data when the torque wrench 100 reaches a peak.

Although exemplary embodiments of the torque wrench calibration automation system according to the present invention have been described above, the present invention is not limited thereto, and various modifications can be made within the scope of the claims, the description of the invention, and the accompanying drawings, and these also fall within the scope of the present invention.

1. A torque wrench calibration automation system comprising:
a main body;
a handle rotation driving unit; and
a handle push driving unit,
wherein the main body includes a reference part collecting data required for calibration, transmitting the data, and receiving a control signal, a head fixing part fixing a position of a torque wrench head, a main body base having a flat upper surface, and a handle base that moves linearly on an upper portion of the main body,
the handle rotation driving unit includes a handle rotation motor installed on the handle base of the main body, and a handle rotation module connected to a front end of the handle rotation motor and receiving a rotational force of the handle rotation motor to rotate the handle part of the torque,
the handle rotation module includes a pneumatic supply unit providing a pneumatic pressure necessary for mounting or dismounting the handle part of the torque wrench, and a chuck that operates by having a plurality of jaws operating to hold or release a rear end of the handle part of the torque wrench in a circumferential direction using the pneumatic pressure provided from the pneumatic supply unit to mount the torque wrench on the main body, and
an elastic contact member made of an elastic material is installed on one side surface of each of the plurality of jaws.

2. The torque wrench calibration automation system of claim 1, wherein the elastic contact member is installed in a protruding state to come into contact with an outer circumferential surface of the handle part earlier than a front end surface of the jaw coming into contact with the handle part of the torque wrench.

3. The torque wrench calibration automation system of claim 2, wherein the elastic contact member is installed to rotate using a hinge pin to move away from the side surface of the jaw and then come into close contact with the side surface of the jaw.

4. The torque wrench calibration automation system of claim 3, wherein an air cylinder is further installed between the elastic contact member and the jaw to apply a force to the elastic contact member in a direction in which a front end portion of the elastic contact member moves away from the side surface of the jaw.

5. The torque wrench calibration automation system of claim 3, wherein a restoring spring is further installed between the elastic contact member and the jaw to apply a force to the elastic contact member in a direction in which a front end portion of the elastic contact member comes into close contact with the side surface of the jaw.
